(19) United States
(12) Patent Application Publication
(10) Pub. No.: US 2015/0322994 A1
(43) Pub. Date: Nov. 12, 2015

(54) NUT OR OTHER INSERT WITH TORQUE AND PULLOUT RESISTANCE

(71) Applicants: Robert B. MANGAPORA, Canfield, OH (US); Douglas F. WEINGART, Canfield, OH (US)

(72) Inventors: Robert B. MANGAPORA, Canfield, OH (US); Douglas F. WEINGART, Canfield, OH (US)

(21) Appl. No.: 14/705,415

(22) Filed: May 6, 2015

Related U.S. Application Data
(60) Provisional application No. 61/989,190, filed on May 6, 2014.

(51) Int. Cl. F16B 39/34; F16B 37/04

(52) U.S. Cl. CPC F16B 39/34; F16B 37/04

(57) ABSTRACT

Disclosed is a nut or an insert that includes a body having a through opening, which may be threaded, a deformable pilot portion having an annular wall surrounding the opening, and anti-rotation features arranged around the pilot portion that resist rotation of the nut or the insert due to an applied torque when the nut or the insert is installed in a sheet of metal, the pilot portion being deformable to form a lip or a flange to trap a portion of the sheet between the body and the lip or the flange to resist pull out. Disclosed is also a system that includes the nut or the insert and a tool for installing the nut or the insert in a hole in a sheet of material.

### CROSS-REFERENCE TO RELATED APPLICATION

This application claims the benefit and priority of U.S. Provisional Application No. 61/989,190, filed May 6, 2014, and entitled NUT WITH ROTATION PREVENTION, the disclosures of which are incorporated by reference herein.

### BACKGROUND

Nuts or other inserts installed in a hole defined in a sheet material may be rotated when a torque is applied and may be pulled out of the hole by axial force applied to the nut or the insert, e.g. when the nut is pulled away from the sheet after installation.

### SUMMARY OF THE INVENTION

An objective of the present invention is a nut or an insert insertable in a hole pierced in a host material, such as a plate or sheet of metal, that resists rotation induced by an external torque when the nut or insert is installed in the sheet.

Another objective of the present invention is a nut or an insert insertable in a hole pierced in a host material, such as a plate or sheet of metal, that resists being pulled out under an axial force applied to the nut or the insert.

Another objective of the present invention is securing of a nut or an insert installed in a hole defined in a plate or a sheet to prevent rotation of the nut in the hole upon tightening or loosening of a threaded body in the threaded opening of the nut.

Another objective of the invention is preventing a nut or an insert from being pulled out after installation in the sheet or in the plate.

A further objective of the present invention is a nut or an insert that includes a body having a through opening, which may be a threaded through opening, a deformable pilot portion having an annular wall surrounding the through opening in the nut or the insert, and anti-rotation features arranged around the pilot portion that prevent rotation of the nut or the insert due to an applied torque when the nut is installed on a sheet of metal, the nut or the insert including a feature that prevents the nut or the insert from being pulled out under an applied axial force after it has been installed.

The present invention is further concerned with a system that includes a nut or an insert according to the present invention and a tool for installing the nut or the insert in a hole defined in a sheet of material, such as a sheet of aluminum or a sheet of steel.

A nut or an insert according to the present invention is configured for insertion into a hole in a sheet.

A nut or an insert according to the present invention may include a body having a through opening, a bottom surface and a top surface; a deformable pilot portion having an annular wall surrounding the opening in the body and extending from the top surface of the body to a top, free end; an annular surface surrounding the pilot portion; and a plurality of spaced anti-rotation features on the annular surface arranged around the pilot portion.

In one embodiment, the though opening may be threaded.

Each anti-rotation feature may include a protrusion, for example, a spline.

The nut or the insert may further include a plurality of keyways, each keyway being positioned at a location corresponding to a respective location of a respective spline.

The pilot portion may include a base opposite the top, free end and located at the annular surface. The annular surface may include an inner diameter adjacent the base of the pilot portion and an outer diameter surrounding the inner diameter. The annular surface may decline from the outer diameter toward the inner diameter, which is below the outer diameter.

Each spline may be wedge-shaped. Each wedge-shaped spline may be defined by two inclined surfaces rising from the annular surface to meet at an edge to define a wedge edge.

Each keyway may be a longitudinally extending groove or depression.

Each spline may be spaced from the pilot portion to define a gap.

Each keyway may be spaced from another keyway by a distance and each spline may be spaced from another spline by a distance. The distances between the keyways may be the same and the distances between the splines may be the same. The splines and the corresponding keyways may be at the same positions around the pilot portion.

In one exemplary embodiment, there are six keyways and six splines, although more or fewer splines and keyways can be provided without deviating from the present invention.

In one embodiment, a nut or an insert according to the present invention may include a body having a through opening, a bottom surface and a top surface, the top surface including a first annular surface and a second annular surface surrounding the first annular surface. A deformable pilot portion having an annular wall surrounding the opening in the body extends from the top surface of the body to a top, free end, the deformable pilot portion having a base at the top surface of the body. The first annular surface surrounds the pilot portion and has an inner diameter adjacent the base of the pilot portion. A plurality of spaced complementary splines and keyways are arranged around the pilot portion, each keyway being aligned with a respective one of the splines.

In the one embodiment, the first annular surface slopes downwardly from the second annular surface toward the base of the pilot portion, the keyways are defined in an exterior annular surface of the pilot portion, and the splines are arranged on the first annular surface. Each spline may be a wedge-shaped protrusion that includes a wedge edge. Each spline resides on the first annular surface at a respective annular position and each keyway is a depression or a groove defined on an exterior surface of the pilot portion and located at a location corresponding to a respective annular position of a respective spline. Each spline may be spaced from the pilot portion by a gap.

In the one embodiment, the annular wall of the pilot portion thickens from the top, free end toward the base of the annular pilot portion.

In the one embodiment, the through opening may be threaded.

A system according to the present invention includes a nut or an insert configured to be installed onto a sheet having a hole, and a tool for installing the nut.

The nut or the insert includes a body having a through opening, a bottom surface and a top surface. The top surface may include a first annular surface and a second annular surface surrounding the first annular surface.

The nut or the insert may further include a deformable pilot portion having an annular wall insertable into the hole in the sheet, surrounding the through opening in the body and extending from the top surface of the body.

The deformable pilot portion may have a top, free end, a base at the top surface of the body and an interior surface defining an opening connected to the through opening of the body. The first annular surface may surround the pilot portion and have an inner diameter adjacent the base of the pilot portion.

The tool may include an insert having an insertion end receivable into the opening defined by the annular wall of the pilot portion and a base residing on a surface of the tool that is larger than the hole in the sheet.

The insertion end may have a diameter that is smaller than the diameter of the opening defined by the annular wall of the pilot portion. The base of the insert may have a diameter that is wider than the diameter of the opening defined by the annular wall of the pilot portion. The insert may have an annular exterior wall that extends from the insertion end to the base of the insert, and is configured so that when the pilot portion is inserted into the hole in the sheet, the insert deforms and flares the pilot portion and folds at least a portion of the pilot portion over regions surrounding the hole in the sheet, thereby sandwiching the regions between the flared portion of the pilot portion and the first annular surface.

The nut or the insert may include a plurality of spaced complementary spline and keyway features arranged around the pilot portion to deform regions surrounding the hole in the sheet.

The splines may be protrusions and the keyways may be grooves or depressions formed in the exterior surface of the annular wall of the pilot portion.

The keyways may be arranged to receive therein regions of the sheet surrounding the hole that are deformed by the splines during installation of the nut with the tool.

A nut according to one embodiment of the present invention is configured to be installed in a hole in a plate or a sheet, with torque resistance, the nut including a body of the nut which engages against the underside of the plate, a pilot portion of the nut protruding up through the hole in the plate, a notch in the plate facing side of the body of the nut, with an anti-rotation device in the notch, the device including gear teeth, other protrusions or other torque resistors. The pilot is then pressed toward the top side of the sheet above which the pilot protrudes, pressing the thin top region of the nut body against the inner circumferential region of the sheet around the hole in the sheet and that region of the sheet is pressed into the notch against the torque resistant anti-rotation elements in the notch.

Other features and advantages of the present invention will become apparent from the following description of the invention which refers to the accompanying drawings.

### BRIEF DESCRIPTION OF THE DRAWINGS

FIGS. 1A and 1B are respectively side and sectional views of a plate which receives a nut according to the first embodiment of the present invention hereof.

FIGS. 2A and 2B are respectively side and sectional views of a nut according to the first embodiment hereof.

FIGS. 3A and 3B are respectively side and sectional views of the nut according to the first embodiment initially installed in a hole in the plate.

FIGS. 4A and 4B are respectively side and sectional views of the nut according to the first embodiment fully installed in the plate.

FIG. 5 is a perspective view showing the upper and the side of the nut according to the first embodiment.

FIG. 6A depicts a side plan view, FIG. 6B depicts a bottom plan view, and FIG. 6C depicts a top plan view of a nut according to the second embodiment of the present invention.

FIG. 6D is a top perspective view of a nut according to the second embodiment.

FIG. 6E depicts a sectional view along line 6E-6E in FIG. 6C viewed in the direction of the arrows.

FIG. 6F depicts a sectional view along line 6F-6F in FIG. 6C viewed in the direction of the arrows.

FIG. 6G depicts a sectional view along line 6G-6G in FIG. 6C viewed in the direction of the arrows.

FIG. 6H illustrates a key way and spline arrangement in a nut according to the second embodiment.

FIG. 6I is an enlarged view from the circled section 6I in FIG. 6F.

FIG. 6J is a sectional view along line 6J-6J in FIG. 6G.

FIG. 7A is a side plan view of a tool used in a system according to the present invention for the installation of a nut according to the present invention.

FIG. 7B is an enlarged view of section 7B in FIG. 7A.

FIG. 8A is a side view of a tool depicted in FIG. 7A installing a nut or an insert according to an embodiment of the present invention into a hole in a sheet.

FIG. 8B is a cross-sectional view taken along a central longitudinal axis of the assembly illustrated in FIG. 8A.

FIGS. 9A-9D illustrate the steps in the installation of a nut according to the present invention on a sheet using a tool shown in FIG. 8.

FIG. 9E illustrates one view of a nut according to the second embodiment assembled on a sheet taken along line 9E-9E in FIG. 8A viewed in the direction of the arrows.

FIG. 9F illustrates another view of a nut according to the second embodiment assembled onto a sheet taken along line 9F-9F in FIG. 8A viewed in the direction of the arrows.

FIG. 9G illustrates a nut according to the second embodiment with a bent (flared) pilot portion after it has been installed on a sheet, the sheet being removed from the view for better illustration.

FIG. 9H is an enlarged view of circled portion 9H in FIG. 9E.

FIG. 10A is a bottom plan view of a sheet after installation of a nut or an insert according to the second embodiment, the nut being removed from view.

FIG. 10B is an enlarged view of circled portion 10B in FIG. 10A.

FIG. 10C is a side plan view of the sheet shown in FIG. 10A.

FIG. 10D is a cross-section along line 10D-10D in FIG. 10A.

FIG. 10E is an enlarged view of circled section 10E in FIG. 10D.

FIG. 10F is a perspective view of a sheet after installation of a nut or an insert according to the second embodiment, the nut or the insert being removed from view.

FIG. 10G is an enlarged view of circled section 10G in FIG. 10 F.

FIG. 11 is a partial cross-sectional view of a nut according to the second embodiment installed in a sheet of material.

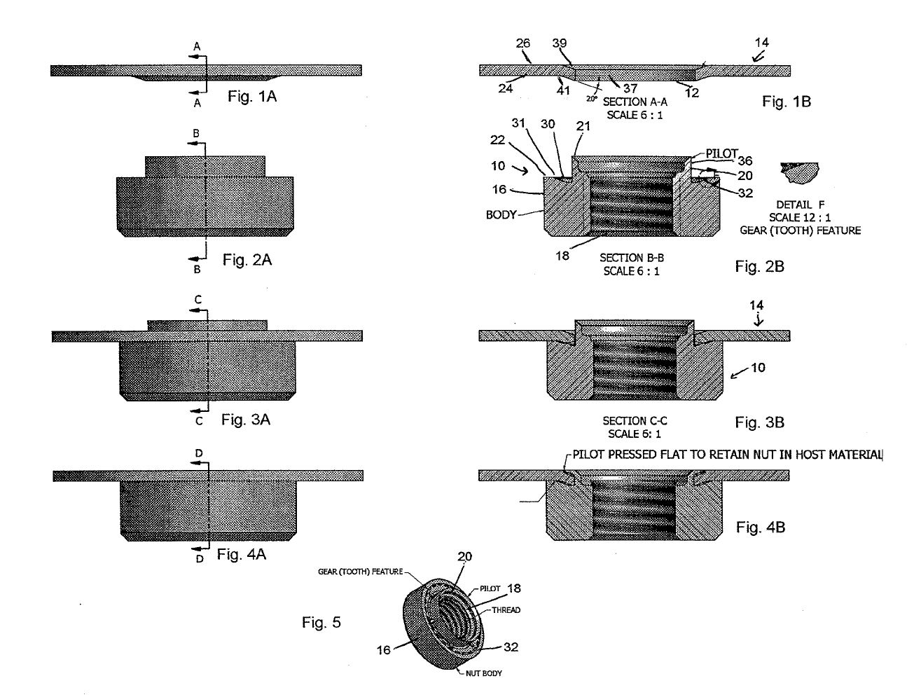

### DESCRIPTION OF THE INVENTION

The nut 10 is positioned in a pierced and formed hole 12 in a host material, e.g., a hole in a metal plate or sheet 14.

The nut 10 has a body 16 with a threaded opening 18 extending axially through the nut body 16. The nut has an upwardly protruding, downwardly deformable pilot portion 20. The body 16 of the nut below the pilot portion 20 has a larger outer diameter than the pilot portion. The outward end 21 of the pilot portion 20 is narrowed and shaped with a tapered thickness defining a wedge shape.

The pilot portion 20 of the nut is passed upward through the preformed hole 12 until the upper or outward side 22 of the body 16 of the nut contacts and is stopped at the underside 24 of the pierced plate 14. The pilot portion 20 now protrudes above the top or outward side 26 of the pierced plate 14.

There is an annular notch 30 located at the top of the body 16 of the nut and at the radially inward region 31 of the body 16 adjacent to the pilot portion 20. The bottom of the notch 30 has protrusions 32 in the form of a circular row of gear teeth 32, for example, for providing torque resistance to the installed nut body. Other shapes of torque resisting elements may be used. With the nut installed in the pierced hole 12, there is space between the radially inward region 39 of the plate around the hole 12 pierced in the host plate and the bottom of the notch 30.

The pilot 20 portion protruding from the top of the body and also above the top 26 of the plate 14 is next pressed or otherwise forced downward from above, which causes the rigid pilot to slightly spread the thin top nut region 36 of the nut body due to wedge action at 21 between the top of the body and the stiffer pilot. The annular periphery of the upper part 36 of the body of the nut engages the interior wall 37 of the hole 12 in the plate and presses the plate region 39 around the hole 12 downward into the notch 30 as in FIG. 3B. The pilot portion 20 is pressed until its top surface is essentially flush with the top surface of the plate, or at least as flush with that surface as possible. The pilot portion presses the top region 36 of the body 16 down upon the top of the radially inner region 39 of the plate around the hole 12 to press that region 39 of the plate against the torque resisting teeth 32 in the notch 30.

The anti-rotation feature is the pressure of the teeth 32 or other elements at the bottom of the notch 30, against the underside circumferential region 41 surrounding the hole 12 in the plate. The body 16 and the flattened pilot portion 14 together securely hold the nut firmly in contact with its anti-rotation feature.

In addition, as the deformable pilot portion is pressed downward, as in FIG. 4B, there maybe a counterforce on the nut to cause the nut to pull out of the hole 12. The nut design prevents the nut from then pulling out. Therefore, both torque resistance and pullout resistance are achieved.

This may be designed for high strength steel applications, but can also be used for lesser strength mild steels and aluminum.

Preferably nut 10, but at least protrusions (teeth) 32, are made of a material that is harder than the material of sheet 14 so that when region 39 is pressed against protrusions 32, protrusions 32 deform sheet 14 when making contact with sheet 14.

In a second embodiment of the present invention, which is considered the preferred embodiment and the best mode, a plurality of complementary keyway and spline features are provided to resist and preferable prevent the nut from rotation induced by an applied torque after the nut is installed. Also, pullout resistance and preferably pullout prevention are achieved.

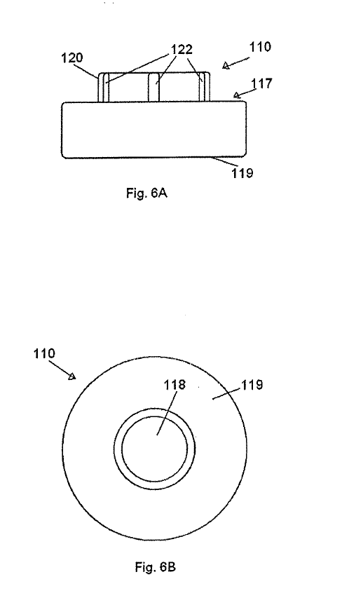

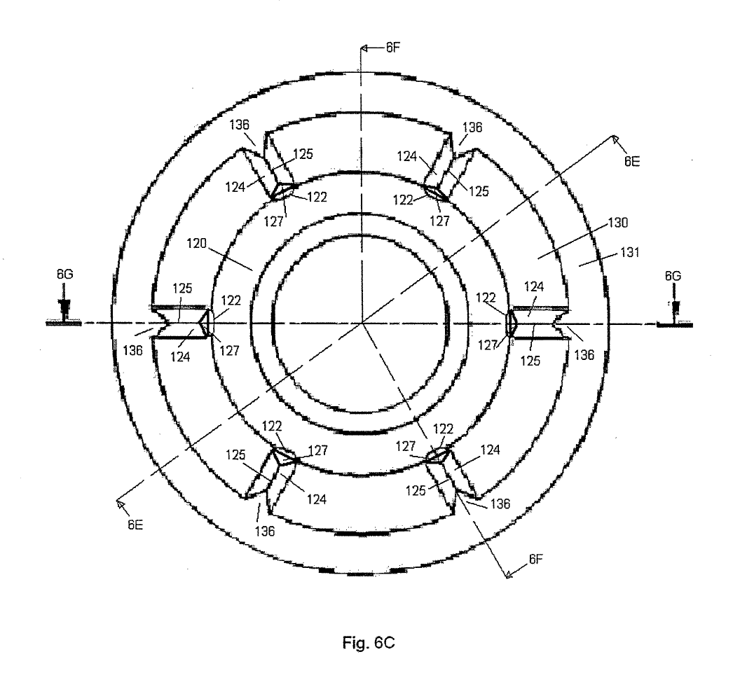

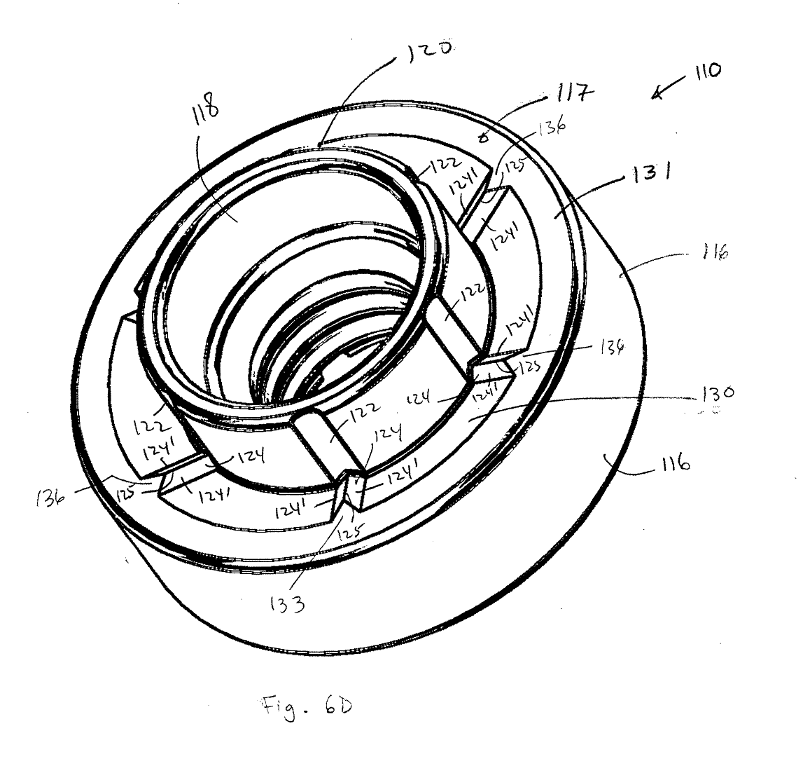

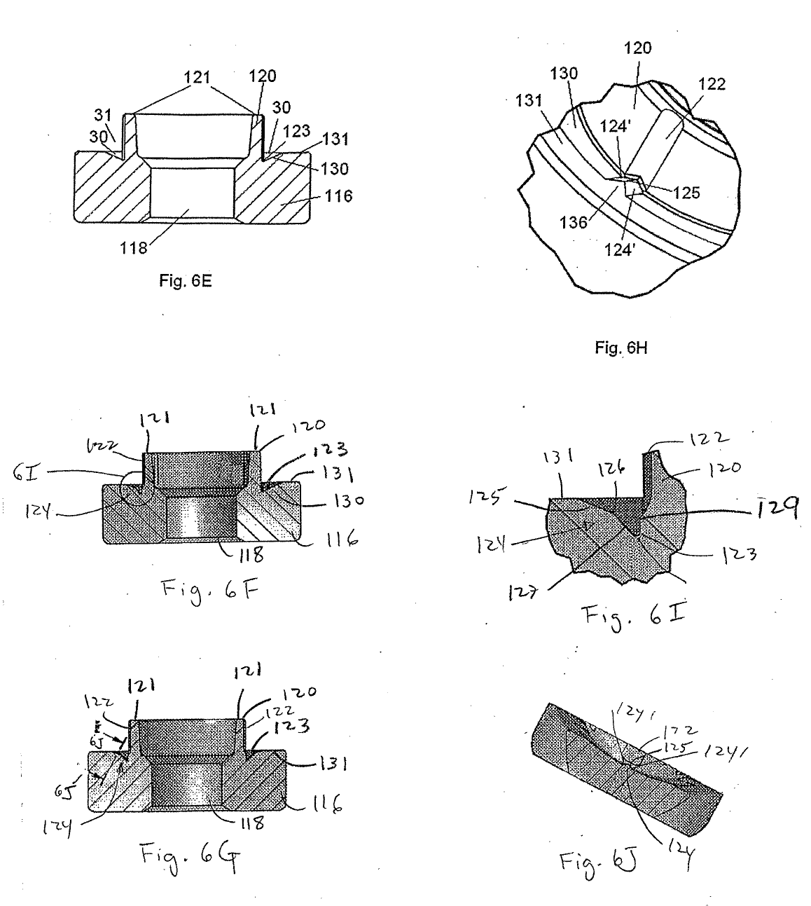

Referring to FIGS. 6A-6J, nut 110 includes a preferably cylindrical body 116. Body 116 includes a threaded through opening 118 that extends from bottom surface 119 of body 116, through body 116, and along its longitudinal axis. However, through opening 118 need not be threaded if it receives other than a threaded bolt or other installed object.

Body 116 includes an annular upper surface 117 opposite bottom surface 119. Annular upper surface 117 surrounds a pilot portion 120, which extends above annular upper surface 117. Preferably, pilot portion 120 is an annular wall that defines and opening surrounding a space that is aligned with the longitudinal axis of nut 110 and is in communication with the interior of threaded opening 118.

As shown in FIGS. 6E-6G, the annular wall defining pilot portion 120 may be thinner at its top, free end 121, than at its base 123, which is connected to body 116, and surrounds threaded opening 118. The annular wall defining pilot portion 120 preferably becomes thicker gradually from its top, free end 121 to its base 123. Pilot portion 120 is configured to be deformable so that it may be folded over in the same manner as the pilot portion in the first embodiment described above.

Annular upper surface 117 includes a first annular surface 130 and a second annular surface 131 surrounding first annular surface 130. A notch 30 (see FIG. 6E) or the like defines first annular surface 130, which is located at a radially inward region 31. First annular surface 130 has an inner diameter adjacent and surrounding base 123 of pilot portion 120, and an outer diameter adjacent and surrounded by inner diameter of second annular surface 131.

Second annular surface 131 is preferably a flat surface that is oriented along a plane that is at a normal angle to the longitudinal axis of body portion 116.

First annular surface 130 extends radially and declines or descends (slopes downwardly) toward pilot portion 120 from its outer diameter to its inner diameter to define an upside down frustoconical surface as illustrated in FIGS. 6D and 6E.

A plurality of radially extending splines 124 are arranged on first annular surface 130. Each spline is preferably an elongated protrusion that projects from annular surface 130 to define a raised surface above surface 130.

Splines 124 are spaced from one another. In the preferred embodiment, each spline 124 is spaced from another spline by an angle. Preferably, the angles between each pair of splines 124 are equal. Thus, in the preferred embodiment, splines 124 are arranged at an equal angular distance from one another. Any number of splines 124 may be used. In the illustrated embodiment, six splines 124 at equal angular spacing are provided, although it should be appreciated that, other than six splines, may be provided. It should be further appreciated that that splines 124 need not be arranged at equal angular distances, although equal distancing is preferred to realize equal performance around pilot portion 120.

A nut 110 according to the second embodiment of the present invention includes a pilot portion 120 having a plurality of keyways 122. Each keyway 122 is oriented to extend along the direction of the longitudinal axis of pilot portion 120, which preferably coincides with the longitudinal axis of body 116. Each keyway 122 is a groove or a depression defined in the exterior annular surface of pilot portion 120, and extends, preferably, from the top end (free end) 121 of pilot portion 120 to a region below second annular surface 131 at or near base 123 of pilot portion 120. In the preferred embodiment, each keyway 122 terminates below second annular surface 131 at a location above base 123 of pilot portion 120 (see FIGS. 6F, 6G and 6I).

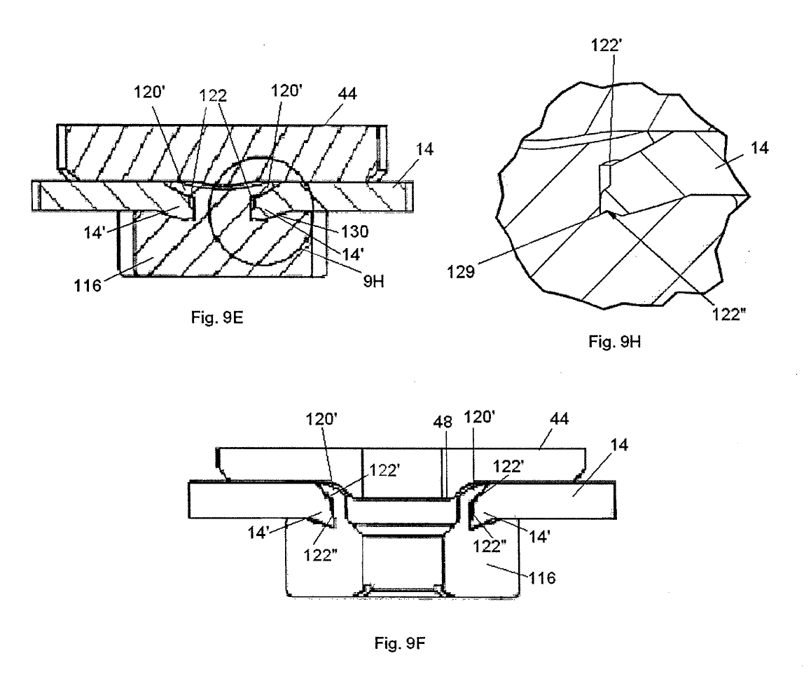

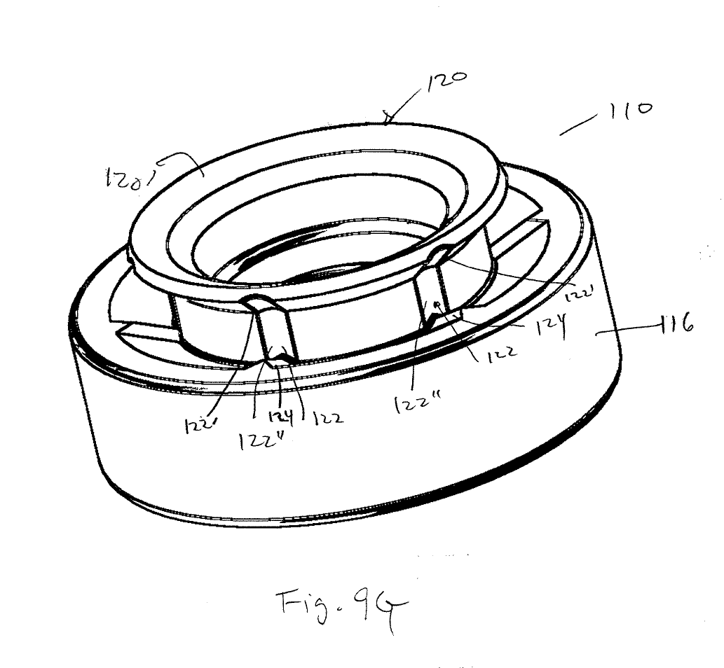

Each keyway 122 and a respective spline 124 are complementary features. Each keyway 124 is located at a position corresponding to an annular location of its complementary spline 124. Thus, when pilot portion 120 is folded over a portion of sheet 14 (described below), a top portion 122′ of each keyway 122 would reside over a respective spline 124 with a portion of sheet 14 residing between the folded top part 120′ (see FIG. 9G) of pilot portion 120 and a respective spline 124. That is, each keyway 122 and a respective spline 124 are positioned so that a portion of sheet 14 would be sandwiched between the deformed (bent) top part 120′ (see FIG. 9G) of pilot portion 120 that includes a top portion of a keyway 124 and a spline 124. More specifically, each spline 124 is configured to deform sheet 14 upon contact and push the part that it deforms into a respective keyway 122 of pilot portion 120 as illustrated, for example, in FIG. 9H (see further description below). Consequently, the rotation of nut 110 relative to sheet 14 can be prevented by the contact with splines 124 and the interior surface of keyways 122.

As explained below splines 124 may be geometrically configured to facilitate the deformation of sheet 14. Furthermore, nut 110 or at least splines 124 may be made of a material that is harder than the material of sheet 14 in order to facilitate the deformation of sheet 14.

A spline 124 can have any suitable configuration that may facilitate the deformation of sheet 14. Referring to FIG. 6D, one preferred configuration of spline 124 may include two surfaces 124′ rising at an angle from first annular surface 130 to meet at an wedge edge 125 to form a wedge to assist the deformation of the sheet.

Referring to FIG. 6I, wedge edge 125 is preferably oriented to decline or descend (slope downwardly) from second annular surface 131 toward pilot portion 120. The angle of descent of wedge edge 125 is shallower than the angle of descent of first annular surface 130 as can be seen in FIGS. 6F and 6I. Angle of descent of wedge edge 125 for each spline 124 is preferably selected so that splines 124 do not extend above second annular surface 131.

Referring to FIGS. 6C and 61, each spline 124 may further include a third inclined surface 127 that extends along a non-normal angle (less than 90° relative to the longitudinal axis of body 116) from a location at or near base 123 (region that includes inner diameter of first annular surface) of pilot portion 120 toward wedge edge 125. Third inclined surface 127 ascends (slopes upwardly) to an apex point 126 that terminates at one end of edge 125 and includes a base 128, opposite its apex, that resides at or near base 123 (in the region that includes the inner diameter of first annular surface 130) of pilot portion 120. Because third surface 127 is inclined, a gap 129 is created between each spline 124 and pilot portion 120 because wedge edge 125 of each spline 124 will not reach pilot portion 120. Each keyway 122 will also be adjacent a respective gap 129 between a spline 124 and pilot portion 122. The gap so created provides room for receiving a portion of sheet 14 during installation.

As seen for example, in FIGS. 6C and 6D, edge 125 meets the apex of a triangular portion 136 of second annular surface 131. Each surface 124′ will have a respective side that terminates at a respective leg of a triangular portion 136, which cross at a triangular apex.

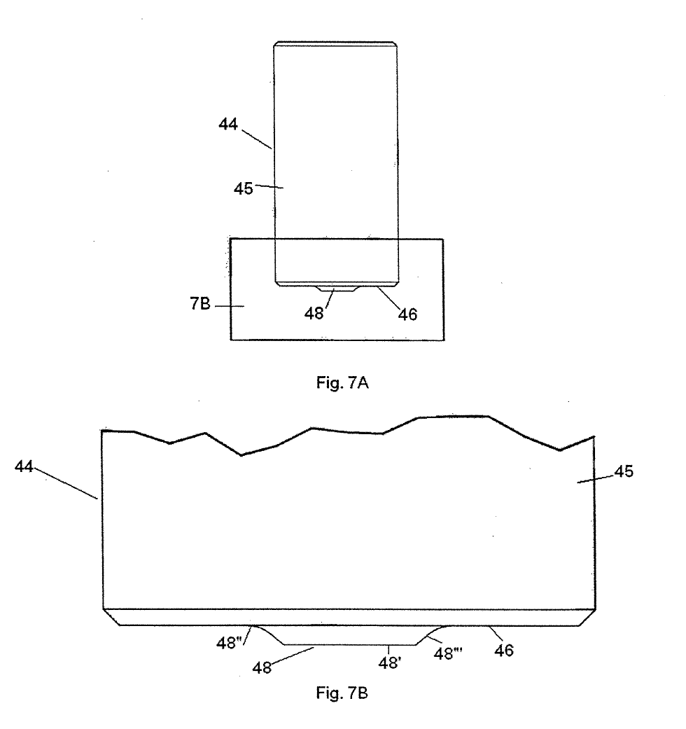

FIGS. 7A and 7B illustrate a side view of a tool 44 suitable for the assembly of a nut 10 or a nut 110 onto a sheet 14. Tool 44 includes, preferably, a cylindrical press 45 with a contact surface 46 having a larger surface area than hole 12 in sheet. Tool 44 includes an insert 48 with an outer diameter at its top end 48′ that is smaller than the inner diameter of the opening defined by pilot portion 20, 120 whereby insert 48 can be received inside pilot portion 20, 120.

Insert 48 has a base 48″ opposite its top end 48′ that has a diameter larger than the inner diameter of pilot portion 20, 120. An annular wall 48′″ resides between top end 48′ and base 48″ of insert 48. Preferably, annular wall 48′″ tapers for a first section to an intermediate point and then is curved from the intermediate point to the base of insert 48. Thus, annular wall 48′″ is configured to deform and flare pilot portion 20 or 120.

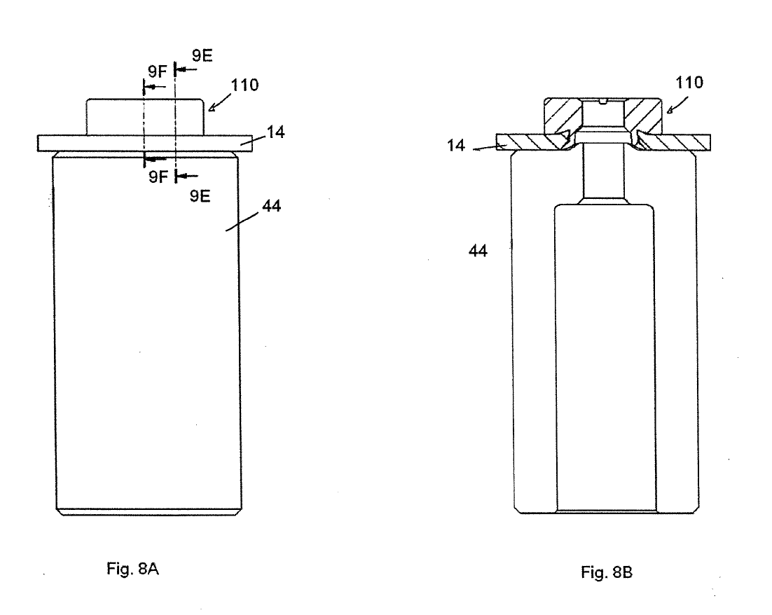

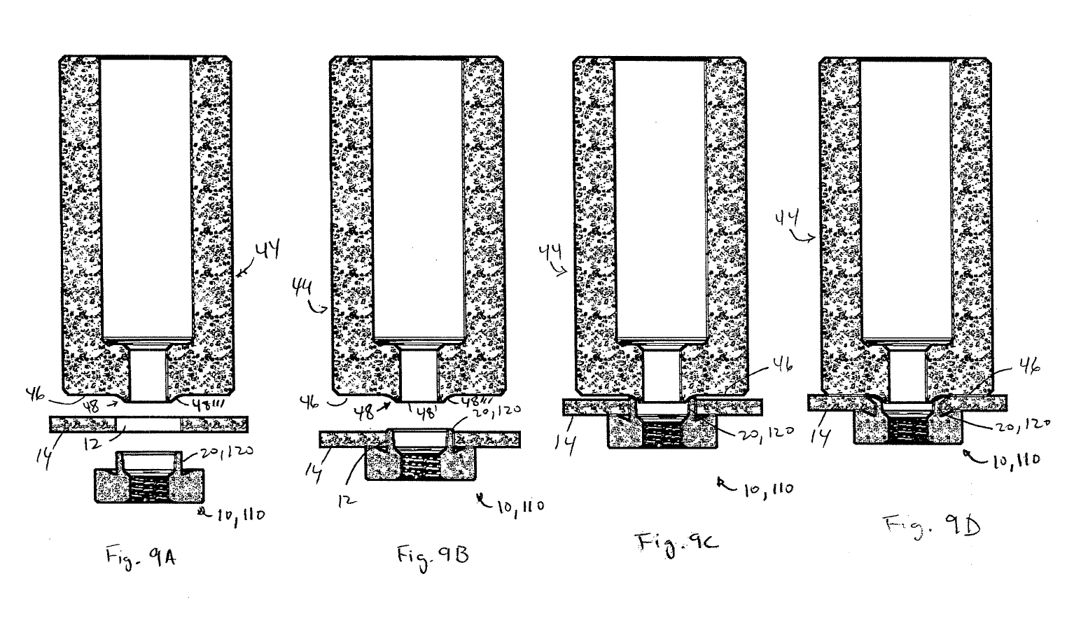

FIGS. 8A and 8B illustrate a tool 44 installing a nut 110 into a hole in a sheet 14.

Referring now to FIGS. 9A to 9D, to install a nut 10, 110, pilot portion 20, 120 of nut 10 or 110 is first inserted in a preferably circular hole 12 that is defined in sheet 14 (e.g. a sheet of aluminum or steel) as illustrated in FIGS. 9A and 9B. Then insert 48 of tool 44 is inserted into and received by pilot portion 20, 120 as illustrated in FIG. 9C As press 44 is moved toward sheet 14, insert 48 deforms pilot portion 120 and flares a top portion of pilot portion 120 to define a flange over the areas surrounding hole 12 in sheet 14. That is, insert 48 spreads pilot portion 120 open and bends a part of its annular wall over sheet 14, as illustrated, for example, in FIGS. 9C and 9D, whereby an annular portion of sheet 14 surrounding hole 18 will be sandwiched between the folded portion of pilot portion 20, 120 and the body 16, 116 of the nut.

Referring to FIGS. 9E and 9F, in the second embodiment, parts of the annular portion 14′ of sheet 14 surrounding hole 18 will be sandwiched between the folded part 120′ of pilot portion 120 and first annular surface 130 (see FIG. 9E), and the other portions will be sandwiched between keyways 122 and splines 124 (see FIG. 9F).

FIG. 9G illustrates nut 110 after deformation of pilot portion 120. Sheet 14 is removed for better illustration. As seen in FIG. 9G, each keyway 122 will include a top portion that will reside over (above) a respective spline 124 (not illustrated) and a bottom portion, below the top portion, which will remain in its original, undeformed state.

Referring to FIG. 9H, which shows an enlarged section 9H in FIG. 9F, according to one aspect of the present invention, portions of sheet 14 sandwiched between folded portion of pilot portion 120 and splines 124 will be deformed to enter into top parts 122′ of keyways 122 (the parts that are folded over a respective spline as illustrated in FIG. 9G), and bottom parts 122″ of keyways (the parts not folded over as illustrated in FIG. 9G). Thus, portions of sheet 14 may be received in the bottom portion 122″ of each keyway 122, in top portion 122′ of each keyway 122, and in gap 129 between a keyway 122 and a respective spline 124. Moreover, each spline 124 may either penetrate or deform portion of sheet 14 with which it makes contact. As a result, upon installation, a nut 110 according to the present invention will prevent or resist rotation that may be induced by an applied torque more effectively. The sandwiching of sheet 14 between annular surface 130 and the bent or flared portion of the annular wall of pilot portion 120 will prevent or resist pull out of nut 110 from the hole defined in sheet 14.

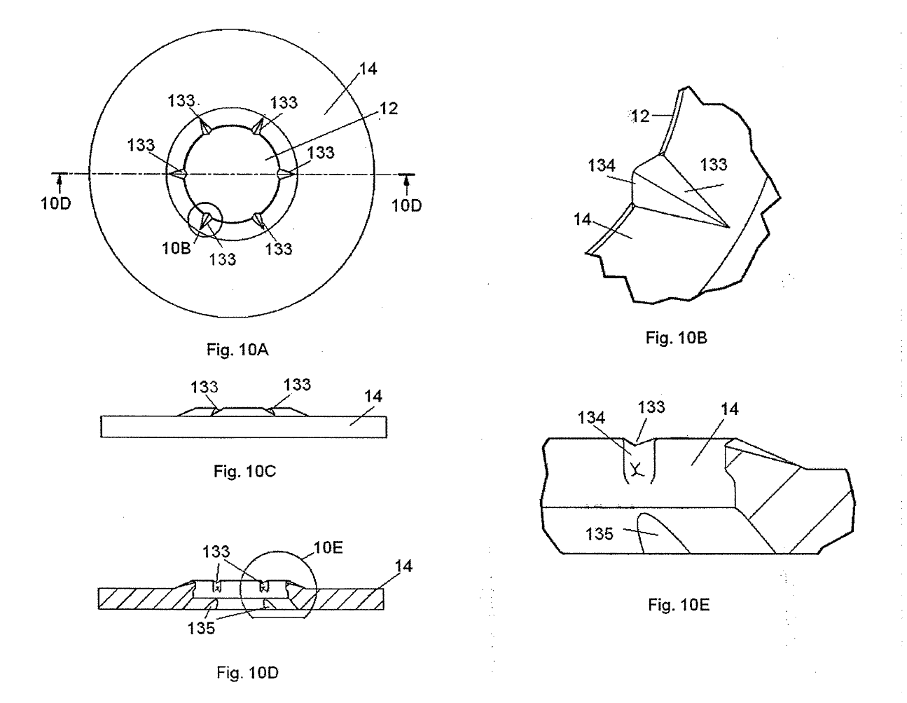

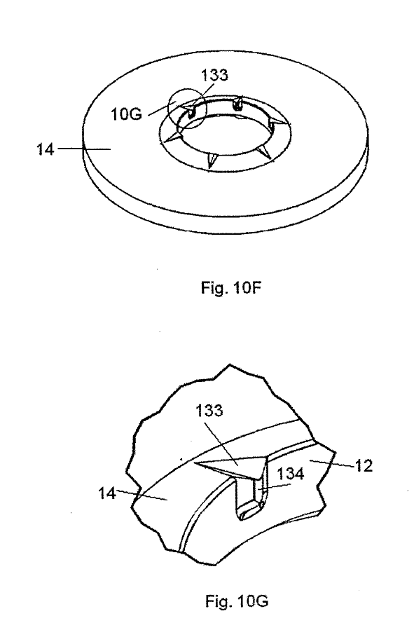

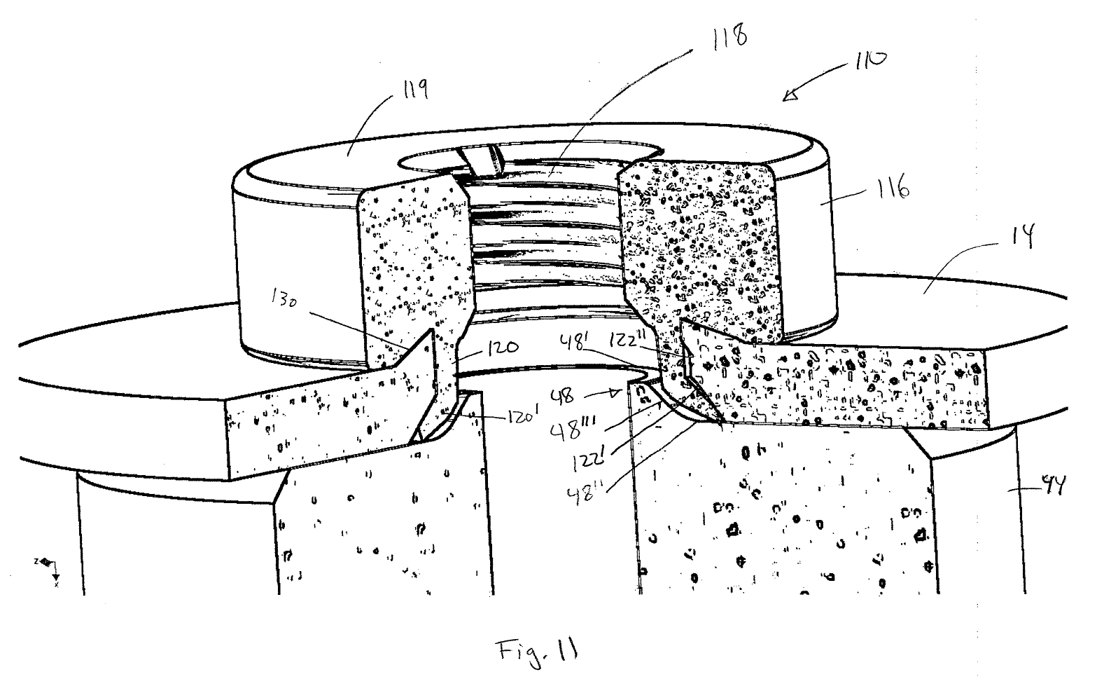

FIG. 10A illustrates sheet 14 after it has been deformed by contact with splines 124. Thus, depressions 133 are formed around hole 18 in sheet 12 after making contact with splines 124.

Referring to FIGS. 10A and 10B (FIG. 10B illustrating enlarged portion 10B in FIG. 10A), deformation of sheet 14 to create each depression causes a protrusion 134 that would be received by a respective bottom part 122″ of a respective keyway 122.

Referring to FIGS. 10C, 10D and 10E (FIG. 10E illustrating enlarged portion 10E in FIG. 10D), a bump 135 may be formed on sheet 14 opposite each depression formed by a spline 124, which bump 135 is then received in a top part 122′ of a keyway 122, which is folded over sheet 14.

FIGS. 10F and 10G further illustrate a depression 133 and a protrusion 134 formed in a sheet 14 after installation of nut 110 according to the second embodiment of the present invention.

FIG. 11 further illustrates a nut or an insert 110 according to the present invention installed in a sheet 14.

While a nut having a body with a threaded opening is disclosed here as the preferred embodiment, it should be clear that the present invention is not limited to a nut, but that any insert with or without a threaded through opening could be within the present invention.

Furthermore, while the splines are disclosed to be located on the first annular surface and the keyways are shown to be on the pilot portion, it should be appreciated that some or all of the splines could be on the pilot portion with corresponding keyways on the first annular surface.

In addition, teeth 32 and splines 124 could be provided together with or without complementary keyways 122 for splines 124.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A nut or an insert for insertion into a hole in a sheet, the nut or the insert comprising:
a body having a through opening, the body having a bottom surface and a top surface;
a deformable pilot portion comprising an annular wall surrounding the opening in the body and extending from the top surface of the body to a top, free end;
an annular surface surrounding the pilot portion; and
a plurality of spaced anti-rotation features on the annular surface arranged around the pilot portion.

2. A nut or an insert according to claim 1, wherein each anti-rotation feature comprises a spline and the nut or the insert further comprises a plurality of keyways, each keyway being positioned at a location corresponding to a respective location of a respective spline.

3. A nut or an insert according to claim 2, wherein the pilot portion includes a base opposite the top, free end and located at the annular surface, and wherein the annular surface includes an inner diameter adjacent the base of the pilot portion and an outer diameter surrounding the inner diameter, the annular surface declining from the outer diameter toward the inner diameter, and declining further below the outer diameter.

4. A nut or an insert or an insert according to claim 3, wherein each spline is wedge-shaped.

5. A nut or an insert according to claim 4, wherein each spline includes two inclined surfaces rising from the annular surface to meet at an edge to define a wedge edge.

6. A nut or an insert according to claim 5, wherein each spline is spaced from the pilot portion to define a gap.

7. A nut or an insert according to claim 2, wherein each keyway is a longitudinally extending groove or depression.

8. A nut or an insert according to claim 2, wherein each keyway is spaced from another keyway by a distance and each spline is spaced from another spline by a distance, and wherein distances between the keyways are the same and the distances between the splines are the same, and the splines and the corresponding keyways are at the same positions around the pilot portion.

9. A nut or an insert according to claim 8, wherein there are six keyways and six splines.

10. A nut or an insert according to claim 1, wherein the pilot portion includes a base opposite the top, free end and located at the annular surface, and wherein the annular surface includes an inner diameter adjacent the base of the pilot portion and an outer diameter surrounding the inner diameter, the annular surface declining from the outer diameter toward the inner diameter.

11. A nut or an insert, comprising:
a body having a through opening, the body having a bottom surface and a top surface, the top surface including a first annular surface and a second annular surface surrounding the first annular surface;
a deformable pilot portion comprising an annular wall surrounding the opening in the body and extending from the top surface of the body to a top, free end, the deformable pilot portion having a base at the top surface of the body, the first annular surface surrounding the pilot portion and having an inner diameter adjacent the base of the pilot portion; and
a plurality of spaced complementary splines and keyways arranged around the pilot portion, each keyway being aligned with a respective of the splines.

12. The nut or the insert of claim 11, wherein each keyway comprises a groove or a depression and each spline comprises a protrusion.

13. The nut or the insert of claim 11, wherein each keyway is defined in an exterior annular surface of the pilot portion and each spline projects from the first annular surface.

14. The nut or the insert of claim 11, wherein the first annular surface slopes downwardly from the second annular surface toward the base of the pilot portion, the keyways are defined in an exterior annular surface of the pilot portion and the splines are arranged on the first annular surface.

15. The nut or the insert of claim 11, wherein the annular wall of the pilot portion thickens from the top, free end toward the base of the annular pilot portion.

16. The nut or the insert of claim 11, wherein each spline is a wedge-shaped protrusion that includes a wedge edge, each spline residing on the first annular surface at a respective annular position and each keyway being a depression or a groove defined on an exterior surface of the pilot portion and located at a location corresponding to a respective annular position of a respective spline.

17. The nut or the insert of claim 16, wherein each spline is spaced from the pilot portion by a gap.

18. A system that includes a nut or an insert configured to be installed onto a sheet having a hole, and a tool for installing the nut or the insert, wherein
the nut or the insert includes a body having a through opening, the body having a bottom surface and a top surface, the top surface including a first annular surface and a second annular surface surrounding the first annular surface; the nut or the insert further including a deformable pilot portion comprising an annular wall insertable into the hole in the sheet, surrounding the through opening in the body and extending from the top surface of the body, the deformable pilot portion having a top, free end, a base at the top surface of the body and an interior surface defining an opening connected to the through opening of the body, the first annular surface surrounding the pilot portion and having an inner diameter adjacent the base of the pilot portion;
and wherein
the tool includes an insert having an insertion end receivable into the opening defined by the annular wall of the pilot portion and a base residing on a surface of the tool that is larger than the hole in the sheet, the insertion end having a diameter that is smaller than diameter of the opening defined by the annular wall of the pilot portion and the base of the insert having a diameter that is wider than the diameter of the opening defined by the annular wall of the pilot portion, the insert having an annular exterior wall that extends from the insertion end to the base of the insert, and wherein
the annular exterior wall of the insert is configured so that when the pilot portion is inserted into the hole in the sheet, the insert deforms and flares the pilot portion and folds at least a portion of the pilot portion over regions surrounding the hole in the sheet, thereby sandwiching the regions between the flared portion of the pilot portion and the first annular surface.

19. The system of claim 18, wherein the nut or the insert includes a plurality of spaced complementary spline and keyway features arranged around the pilot portion to deform regions surrounding the hole in the sheet.

20. The system of claim 19, wherein the splines are protrusions and the keyways are grooves or depressions formed in the exterior surface of the annular wall of the pilot portion, and wherein the keyways are arranged to receive therein regions of the sheet surrounding the hole that are deformed by the splines during installation of the nut or the insert with the tool.
